(19) United States
(12) Patent Application Publication
(10) Pub. No.: US 2006/0283453 A1
(43) Pub. Date: Dec. 21, 2006

(54) Refillable filter mask cartridge

(76) Inventor: Randy Haddad, Yorba Linda, CA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/153,838

(22) Filed: Jun. 15, 2005

(51) Int. Cl. A62B 19/00; A62B 18/08; A62B 23/02; A62B 7/10

(52) U.S. Cl. 128/205.29; 128/206.17; 128/205.27; 128/206.16; 128/206.19

(57) ABSTRACT

A refillable filter mask cartridge is disclosed. The refillable filter mask cartridge includes a canister, a cover, removably attached to the canister, filter media, disposed within the canister, and a first filter; disposed within the canister proximate to the filter media.

### FIELD OF THE INVENTION

The present invention is related to the area of charcoal filter mask cartridges, and in particular to refillable charcoal filter mask cartridges.

### BACKGROUND OF THE INVENTION

It is often important in industry where particulates are in the air to ensure that workers are protected from inhaling toxic particulates. The more downtime a worker has, the more costly it is to production. Therefore, keeping workers healthy by not having them inhale toxic particulates in an industry where they are abundant is critically important to employers. To protect workers from these toxins, a number of systems have been employed by industry. One of the most common techniques is to filter out the toxic particulates before the worker inhales them, and one of the most effective and convenient ways of achieving this is with a respirator worn by the individual employee, which houses a filtering system. To this end, a number of filtering methods and respirator packages have been introduced to the market. However, unless filters are changed often enough, they become clogged and do not filter out the particulates as effectively, causing workers to inhale toxic particulates. Also, if the filters are not convenient to change, they will not be changed by the workers often enough.

U.S. Pat. No. 5,505,197 is directed to a respirator mask, including a unitary body member formed of a flexible rubberlike material and having an inner surface to fit and seal upon the face of a user. The body member including at least one opening to receive a filter cartridge and including an internally extending flange portion forming the circumference of the opening. A filter cartridge formed of a substantially rigid material and including an inner grooved portion having a shape substantially complementary to the internally extending flange portion of the body member and with the flange portion for reception within the grooved portion of the cartridge to provide for the cartridge being locked within the opening in the body portion. The internally extending flange portion of the body member and the grooved portion of the cartridge forming a seal to prevent any passage of air from the outside to the inside of the mask, except through the filter cartridge.

U.S. Pat. No. 4,385,989 is directed to a novel filter assembly and filter cartridge therefor for use in an under-gravel filtration system in an aquarium tank. The filter assembly includes an airlift tube, a filter cartridge removably secured to the upper end of the airlift tube, and a tubular member extending through the filter cartridge and into the airlift tube. An aerator disposed near the bottom of the airlift tube is connected to the tubular member by air tubing. The top and bottom walls of the filter cartridge are apertured. When air is forced down the tubular member and out the aerator, the rising air bubbles in the airlift tube draw water up the airlift tube and into the filter cartridge through the openings in the bottom wall, the water being returned to the aquarium tank through the openings in the top wall.

U.S. Pat. No. 4,749,390 is directed to a filtering unit has four filter holders arranged in a rectangle around a blower. Each filter holder holds up to two filter elements. The blower draws air through the filter elements and outputs filtered air through a vent. Refillable filter frames are provided to allow the user to change the filter material. In one embodiment, glass chips are used as the filter material.

U.S. Pat. No. 5,064,453 is directed to a filter system with refillable filter beds containing filter media. The media is drained from the filter beds through filter media outlets located directly under the refillable filter beds. The filter media is kept below desorption temperature by opening a bypass air inlet and using a blower.

U.S. Pat. No. 5,063,926 is directed to a respirator cartridge having body, cover and filter media elements, and including a sealant dispersion member in one of the body or cover elements. The dispersion member directs the sealant material to the peripheral edge of the filter media without wetting the filtering surface of the media. An improved method for rotational molding filter media in/or for a filter assembly is also provided.

U.S. Pat. No. 5,080,094 is directed to a face mask is disclosed that can be reusable or disposable, and which filters particulate matter and noxious and poisonous gasses from breathed air. The mask has a mask shell that is thermoformed of cross-linked, closed-cell foam sheet that is impermeable to air while having good shape retention and elasticity. The mask shell is perforated with multiple holes in its central area to permit inhaled air to pass through the otherwise impermeable shell. This mask shell is stiff enough to support filter liners made of, for example, an activated charcoal impregnated fibrous sheet that covers the holes and is retained to the inside and/or the outside of the mask shell by a retainer which is easily removed to replace the filter liner(s). Alternatively, the filter liner(s) may be bonded to the inside and/or the outside surface of the foam mask shell to make a disposable mask. A one-way valve is mounted through the wall of the mask shell to exhaust exhaled air.

U.S. Patent Application No. 2004/0007234 is directed to a respiratory protection air-purifying device that minimizes the area required in front of the face, especially around the mouth area, by locating the very lightweight filter and plenum close to the head, connected by a airway tube forming a complete unit with the mouthpiece in the mouth, supported by the mouth. The airway tube and the filter plenum are both of minimal internal area and close to the mouthpiece, thus minimizing the internal volume of used air, residual nitrogen, and making the outside dimensions small enough to be compatible with most safety equipment. The respirator requires no straps and is preferably provided with a small tether to the nose clip and is worn in front of the head with the mouthpiece inserted into the mouth, the filter then supported by the mouth, and the nose clip secured on the nose.

None of the above identified inventions, however, provide a refillable charcoal gas filter mask cartridge that can easily be refilled when the charcoal filtrate becomes clogged. Furthermore, it would be beneficial if the refillable charcoal filter mask cartridge could be refilled with charcoal filtrate and filter pads that can be purchased and stored in bulk quantities and used to refill the filter mask cartridges whenever needed.

### OBJECTS AND SUMMARY OF THE INVENTION

It is therefore an object of the present invention to provide a refillable filter mask cartridge that can be easily and efficiently refilled.

In accordance with a first aspect of the present invention, a refillable filter mask cartridge is provided. The refillable filter mask cartridge includes a canister, a cover, removably attached to the canister, filter media, disposed within the canister, and a first filter; disposed within the canister proximate to the filter media.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is a perspective view of a refillable filter mask cartridge in accordance with the present invention.

FIG. 2 is an exploded view of the refillable filter mask cartridge of FIG. 1.

FIG. 3 is a side elevation view, in partial cross section of the refillable filter mask cartridge of FIG. 1.

FIG. 4 is a perspective view of an alternative embodiment of a refillable filter mask cartridge in accordance with the present invention.

FIG. 5 is an exploded view of the refillable filter mask cartridge of FIG. 4.

FIG. 6 is a side elevation view, in partial cross section of the refillable filter mask cartridge of FIG. 4.

### DETAILED DESCRIPTION OF THE PREFERRED EMBODIMENTS

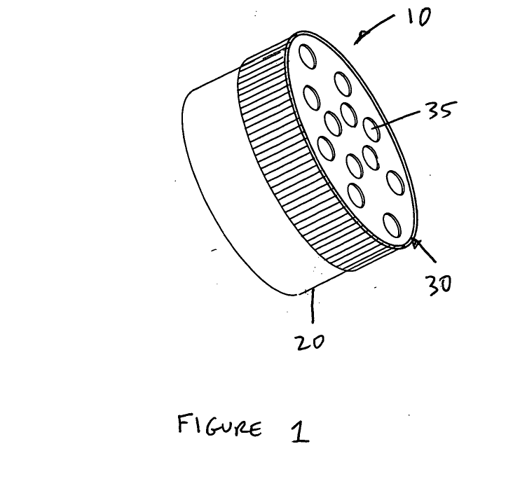

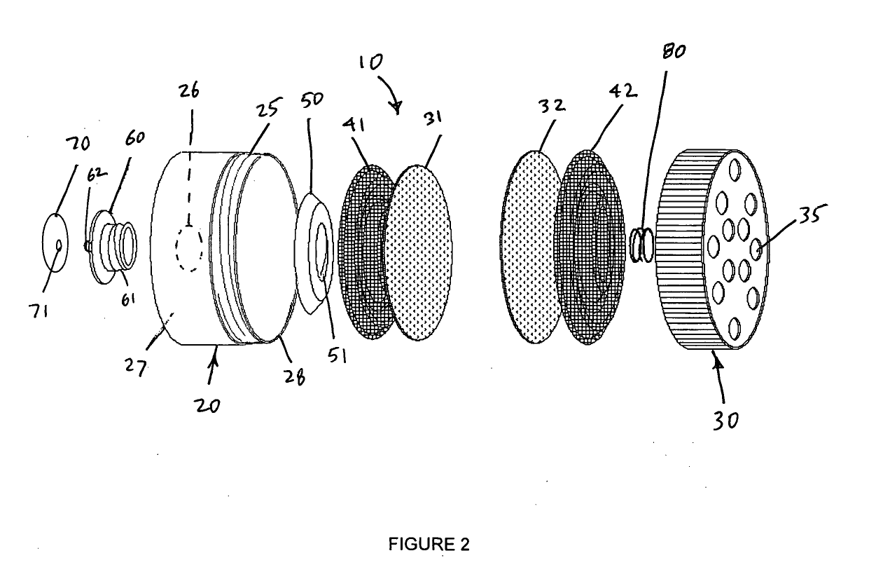

Referring now to the drawings, wherein like reference numerals refer to the same components across the several views and in particular to FIGS. 1 and 2, there is shown a refillable filter mask cartridge 10. The refillable filter mask cartridge 10 includes a canister 20 and a cover 30.

The canister 20 is substantially cylindrical in shape, has a substantially closed side 27 and a substantially open side 28 opposite the substantially closed side 27. The canister 20 is hollow so as to receive components that allow the refillable filter mask cartridge 10 to function as a filter mask. Formed about the circumference of the substantially open side 28 of the canister 20 are threads 25. A hole 26 is formed into the substantially closed side 27 of the canister 20. Removably disposed within the canister 20 is a retainer ring 50. The retainer ring 50 is mounted generally flush with the substantially closed side 27 and includes a threaded opening 51. A valve 60 is mounted through the hole 26 on the substantially closed side 27 of the canister 20. A threaded portion 61 threadedly engages the threaded opening 51 to secure the valve 60 to the retainer ring 50. A flapper 70 includes a hole 71 which is placed over a protrusion 62 on the valve 60 to mount the flapper 70 to the valve 60.

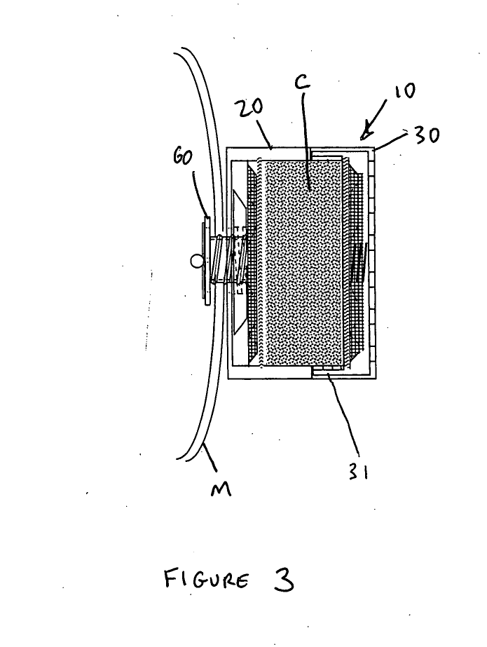

Referring now to FIGS. 2 and 3, the cover 30 includes a plurality of holes 35 and an internal thread 31. The cover 30 is threadedly attached to the canister 20 by threading the internal thread 31 onto the threads 25 of the canister 20 to secure the cover 30 to the canister 20. Disposed within the refillable filter mask cartridge 10 are filter media C. The filter media C in a preferred embodiment of the present invention are activated charcoal granules, however any filter media known to one of ordinary skill in the art may be employed in substitution of activated charcoal granules. Immediately encasing the filter media C are a first filter 31 and a second filter 32. The first filter 31 is disposed proximate to the filter media C and between the filter media C and the retainer ring 50. Disposed between the retainer ring 50 and the first filter 31 is a first mesh spacer 41. The first mesh spacer 41 creates a space of air between the substantially closed side 27 of the canister 20 and the filter media C.

Disposed proximate to the filter media C on the side opposite the first filter 31 is the second filter 32. A second mesh spacer 42 is disposed between the second filter 32 and the cover 30. A spring 80 is disposed between the cover 30 and the second mesh spacer 42. The spring 80 engages the cover 30 on one end and the second mesh spacer 42 on the other end to provide pressure on the second mesh spacer 42, which ultimately applies pressure on all the components between the second mesh spacer 42 and the substantially closed side 27 of the canister 20, and particularly the filter media C, holding the entire internal components of the refillable filter mask cartridge 10 in place when the cover 30 is threaded onto the canister 20 via the thread 31 onto the threads 25.

The refillable filter mask cartridge 10 is mounted on a filter mask M as depicted in FIG. 3. The threaded portion 61 of the valve 60 protrudes through a hole in the mask M and then into the hole 26 of the substantially closed side 27 of the canister 20, where it is threaded into the threaded opening 51 of the retainer ring 50. In this manner, the refillable filter mask cartridge 10 is secured to the mask M and can be used by a worker in industry. As the worker draws breath, he draws air into the holes 35 of the cover 30 and through the filter media C. The flapper 70 is sucked inward toward the worker and allows filtered air to be breathed in by the worker. When the worker exhales, air is expelled through other one way valves in the filter mask M which are not shown.

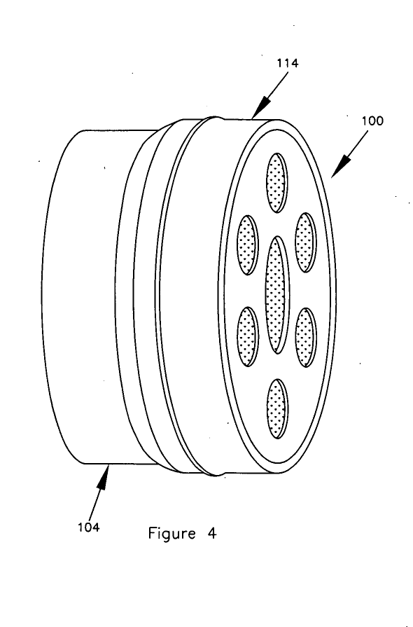

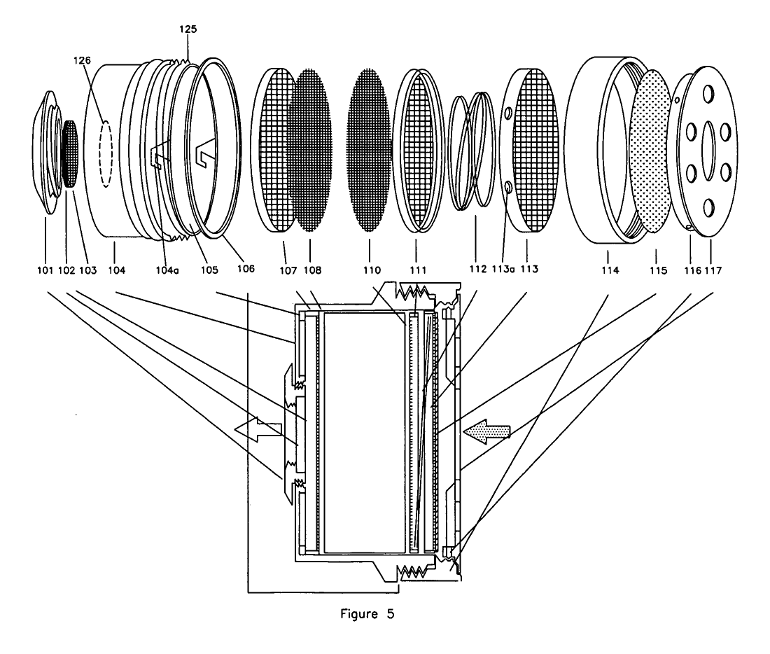

Referring now to FIGS. 4, 5, and 6, an alternative embodiment of a refillable charcoal filter mask 100 is shown. The refillable charcoal filter mask 100 includes a canister 104, a screw on lid 114 and a retainer lid 117.

The canister 104 is hollow so as to receive components that allow the refillable filter mask cartridge 104 to function as a filter mask. Formed about the circumference of the substantially open side of the canister 104 are threads 125. A hole 126 is formed into the substantially closed side of the canister 104. Removably disposed within the canister 104 is a filter retainer mesh 103. A valve is mounted through the hole 126 on the substantially closed side of the canister 104. A threaded portion threadedly engages the threaded opening to secure the valve to the filter retainer mesh 103. A flapper 170 includes a hole 171 which is placed over a protrusion 162 on the valve to mount the flapper 170 to the valve.

The retainer lid 117 includes a plurality of holes. The retainer lid 117 is snap-fit into the lid 114. Disposed within the refillable filter mask cartridge 100 are filter media C. The filter media C in a preferred embodiment of the present invention are activated charcoal granules, however any filter media known to one of ordinary skill in the art may be employed in substitution of activated charcoal granules. Immediately encasing the filter media C are a first filter mesh 108 and a second filter mesh 110. The first filter mesh 108 is disposed proximate to the filter media C and between the filter media C and a seal washer 106. Disposed between the seal washer 106 and the first filter mesh 108 is a first media retainer grating 107. The seal washer 106 creates a space of air between the substantially closed side of the canister 104 and the filter media C.

Disposed proximate to the filter media C on the side opposite the first filter mesh 108 is the second filter mesh 110. A second media retainer grating 111 is disposed between the second filter mesh 110 and the retainer lid 117. A spring 112 is disposed between the second retainer grating 111 and a pre-filter grating 113. The spring 112 engages the media retainer grating 111 on one end and the pre-filter grating 113 on the other end to provide pressure media retainer grating 111, which ultimately applies pressure on all the components between the media retainer grating 111 and the substantially closed side of the canister 104, and particularly the filter media C, holding the entire internal components of the refillable filter mask cartridge 100 in place when the pre-filter grating 113 is snapped into the canister 104 at tabs 113a. In a preferred embodiment of the present invention, the tabs 113a can be secured into the canister 104 by inserting them into a plurality of recesses 104a and rotating the pre-filter grating 113 until the tabs 113a lock into the plurality of recesses 104a. The retainer lid 117 is snapped into the lid 114. A pre-filter 115 is disposed between the pre-filter grating 113 and the retainer lid 114. The retainer lid 117 includes ball plungers 116 disposed about the periphery to hold the retainer lid 117 in place in the lid 114.

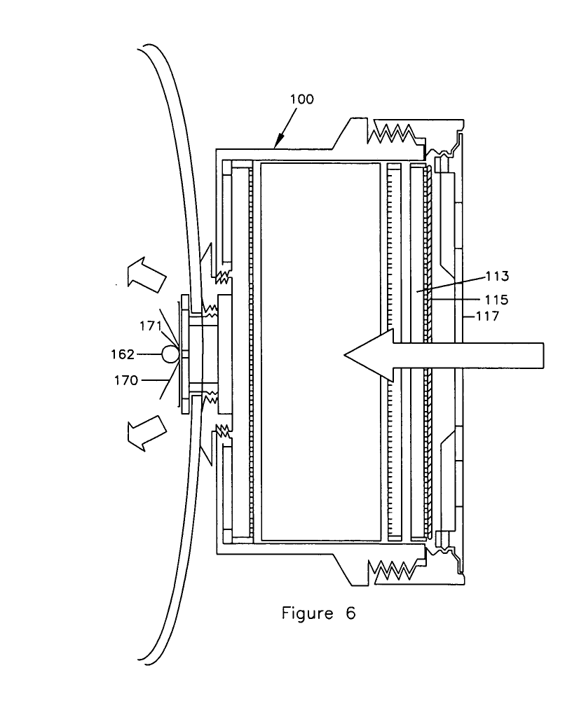

The refillable filter mask cartridge 100 is mounted on a filter mask M as depicted in FIG. 6. The threaded portion of the valve 160 protrudes through a hole in the mask M and then into the hole 126 of the substantially closed side of the canister 104. In this manner, the refillable filter mask cartridge 100 is secured to the mask M and can be used by a worker in industry. As the worker draws breath, he draws air into the holes 135 of the retainer lid 117 and through the filter media C. The flapper 170 is sucked inward toward the worker and allows filtered air to be breathed in by the worker. When the worker exhales, air is expelled through other one way valves in the filter mask M which are not shown.

In view of the foregoing disclosure, some advantages of the present invention can be seen. For example, a novel refillable filter mask cartridge is described. The novel refillable filter mask cartridge can be easily disassembled and refilled with filter media such as charcoal, which can be purchased in bulk and kept on hand to facilitate refilling the refillable filter mask cartridge. Additional items, such as filters can also be kept on hand in bulk supply. No other such cost effective means of providing charcoal filter masks exists in the current state of the art.

While the preferred embodiments of the present invention have been described and illustrated, modifications may be made by one of ordinary skill in the art without departing from the scope and spirit of the invention as defined in the appended claims. For example, in a preferred embodiment of the present invention, the filter media has been described as activated charcoal, however, any filter media known to one of ordinary skill in the art may be employed. Additionally, in a preferred embodiment of the present invention, the mesh spacers are formed out of corrugated metal or plastic, however any material known to one of ordinary skill in the art may be used. The filters in a preferred embodiment of the present invention are fabric, however, any known material known to one of ordinary skill in the art may be employed to form the filters. Additionally, while the preferred methods of attaching the components such as the lids and the canisters together is snap-fitting, press-fitting, and threading, any means known to one of ordinary skill in the art may be employed.

What is claimed is:

1. A refillable filter mask cartridge, comprising:
a canister;
a cover, removably attached to the canister;
filter media, disposed within the canister; and
a first filter; disposed within the canister proximate to the filter media.

2. The refillable filter mask cartridge of claim 1, wherein the filter media is activated charcoal.

3. A refillable filter mask cartridge, comprising:
a canister;
a lid, removably attached to the canister;
a retainer lid, removably attached to the lid;
a pre-filter disposed within the canister;
filter media, disposed between the pre-filter and the canister; and
a compression spring, disposed between the second filter and the retainer lid to hold the filter media in place.

4. The refillable filter mask cartridge of claim 3, wherein the filter media is activated charcoal.
